(19) United States
(12) Patent Application Publication
(10) Pub. No.: US 2015/0091223 A1
(43) Pub. Date: Apr. 2, 2015

(54) METHOD FOR OPERATING A VACUUM MELTING SYSTEM AND VACUUM MELTING SYSTEM OPERATED ACCORDING TO THE METHOD

(71) Applicant: SIEMENS AKTIENGESELLSCHAFT, München (DE)

(72) Inventors: Thomas Matschullat, Eckental (DE); Detlef Rieger, Baldham (DE)

(73) Assignee: SIEMENS AKTIENGESELLSCHAFT, München (DE)

(21) Appl. No.: 14/391,361

(22) PCT Filed: Mar. 21, 2013
(86) PCT No.: PCT/EP2013/055955

§ 371 Date: Oct. 8, 2014

(30) Foreign Application Priority Data
Apr. 11, 2012 (EP) 12163717

(51) Int. Cl. F27D 19/00; F27D 21/00

(52) U.S. Cl. CPC F27D 19/00; F27D 21/00; F27D 2019/0028
USPC 266/44; 266/99; 266/80

(57) ABSTRACT

Metallurgical treatment of a steel melt is provided in a vacuum melting system in which acoustic signals generated in a pan receiving the steel melt are recorded with at least one structure-borne sound pick-up acoustically coupled directly or indirectly to the pan. The acoustic signals are used to determine a variable characterizing the operating state of the vacuum melting system.

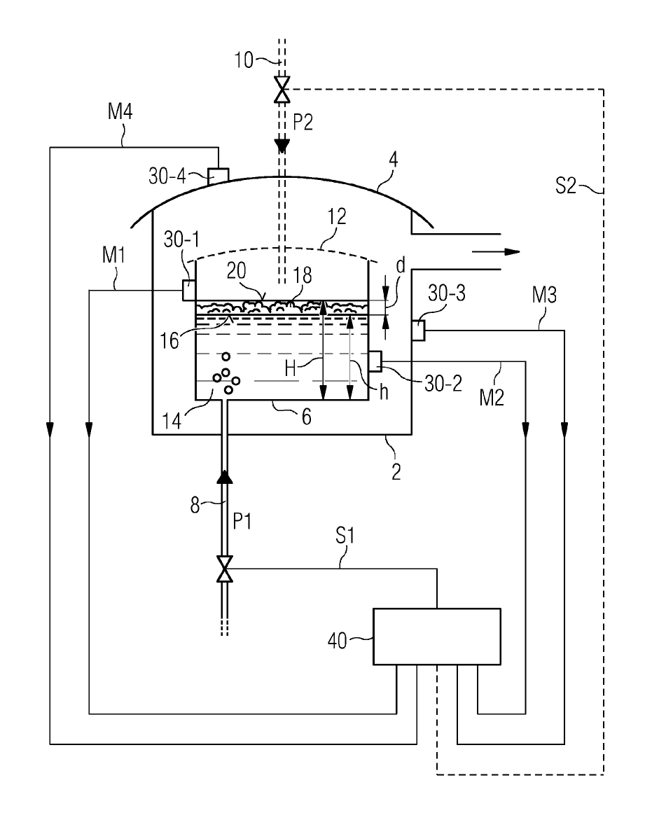

### CROSS REFERENCE TO RELATED APPLICATIONS

This application is the U.S. national stage of International Application No. PCT/EP2013/055955, filed Mar. 20, 2012 and claims the benefit thereof. The International Application claims the benefit of European Application No. 12163717.7 filed on Apr. 11, 2011, both applications are incorporated by reference herein in their entirety.

### BACKGROUND

Described below are a method for operating a vacuum melting system and a vacuum melting system operated according to the method.

In a vacuum melting system a steel melt, produced for example in a preceding step in an electric arc furnace, is subjected to post-processing in order to eliminate undesired accompanying elements still contained in the steel melt. These types of vacuum melting systems are referred to as VD or VOD (Vacuum Decarburization or Vacuum Oxygen Decarburization) systems, depending on whether exclusively an inert gas or additional oxygen is used as the process gas. The process duration, i.e. the period time until the desired content of disruptive accompanying elements is reached essentially depends on the rate with which the process gases are blown into the steel melt. A feeding rate which is too low can lead to the temperature of the steel melts falling so far before the desired content of disruptive accompanying elements is reached that reheating of the steel melt in the pan or a complete post processing of the melt is required. A high feeding rate however, especially with vacuum oxygen decarburization, can lead to an overcooking or overfoaming of the melt, which is associated with a considerable and time-consuming subsequent cleaning effort.

The rate with which the process gas is fed to the steel melt is set manually in such cases by the operator observing the surface image of the melt and thus the height of the foamed slag in the pan by a camera and controlling the feeding rate accordingly. The process control is accordingly dependent on the experience and the attentiveness of an operator, so that incorrect or inefficient process controls cannot be avoided with any certainty. In addition incorrect operating states, such as can be caused for example by leakages of the vacuum system, will only be recognized with great difficulty or recognized very late.

### SUMMARY

The method for operating a vacuum melting system for metallurgical treatment of a steel melt described below improves process security.

In accordance with the method, acoustic signals created in the pan are picked up by at least one structure-born sound pick-up coupled acoustically indirectly or directly to the pan accommodating the steel melt and are employed for detection of a leakage in the vacuum melting system.

The method is based in this case on the idea that acoustic signals arising in the pan during operation of the vacuum melting system, especially during blowing in of the process gas, depending on the point of origin of the signals and the propagation paths to a sound pick up associated therewith, exhibit characteristic properties which make it possible to derive from the acoustic signals information about the operating state of the vacuum melting system and where necessary any leakages arising can be rapidly recognized and rectified.

If the acoustic signals are also employed for determining the height or the depth of the (foamed) slag located in the pan above the melt bath of the steel melt, the danger of an overcooking of the melt can also be recognized in good time and countermeasures, for example reduction or interruption of the feeding of process gas, can be initiated accordingly, which prevent overcooking.

Height of the foamed slag is to be understood below as the location of the upper level of the foamed slag relative to a fixed reference point of the vacuum melting system. This can for example be the distance between the floor of the pan and the upper level. The height of the foamed slag is essentially determined in this case by its depth, since the height of the actual steel melt is practically constant.

Such overcooking or overfoaming can especially be safely prevented if the temporal differential quotient of the height or the depth of the foamed slag is determined. In this way a rapid rise in the height of the foamed slag is recognized in good time.

In an embodiment, the determined height of depth and/or its temporal differential quotient is employed for regulating the height of the foamed slag by controlling the feeding of a process gas into the pan. In this way the entire post processing process executing in a vacuum system can be stabilized accordingly.

The vacuum melting system has at least one structure-born sound pick up acoustically coupled indirectly or directly to the pan for picking up the acoustic signals created in the pan and also a control and evaluation device with an algorithm implemented therein for detecting a leakage in the vacuum melting system from the acoustic signals picked up by the structure-born sound pick-up or pick-ups.

If the at least one structure-borne sound pick-up is fixed to the pan, in particular the sound signals arising within the pan can be registered with high sensitivity.

In a further advantageous embodiment an algorithm is also implemented in the control and evaluation device with which the height H or depth d of the foamed slag and/or the temporal differential quotient of this height H or depth d is determined from the acoustic signals.

### BRIEF DESCRIPTION OF THE DRAWINGS

The properties, features and advantages of the method described above, as well is the manner in which these are achieved, will be explained more clearly and comprehensively in conjunction with the following description of the exemplary embodiments, which will be explained in greater detail in conjunction with the drawing which is

The single drawing FIGURE is a basic schematic diagram of a vacuum melting system.

### DETAILED DESCRIPTION OF THE PREFERRED EMBODIMENT

Reference will now be made in detail to the preferred embodiments, an example of which is illustrated in the accompanying drawing.

In accordance with the FIGURE a vacuum melting system includes a vacuum vessel 2, which is sealed with a cover 4. Inserted into this vacuum vessel 2 is a pan 6 filled with a steel melt, to the underside of which a plurality of gas feed lines 8 for feeding process gas P1 are connected, of which only one is shown in the figure for reasons of clarity. Vacuum vessel 2 and cover 4 accordingly form a system part surrounding the pan 6.

Shown as dashed lines is the form of embodiment of the so-called VOD vacuum melting system, in which oxygen can be introduced into the pan 6 as a further process gas P2 via a further gas feed line 10. In this form of embodiment the pan 6 is additionally covered by a protective cover 12 with which the ejection of slag by overfoaming can be reduced.

In the pan 6 there is a steel melt, which is composed of a liquid melt bath 14, of which the bath level 16 is located at a distance h from the floor of the pan 6, and a foamed slag 18 located above the bath, the depth of which is d, so that the upper level 20 is located at the height H=h+d above the floor of the pan 6.

Disposed on both the outer wall of the pan 6 and also on the wall of the vacuum vessel 2, as well as on the cover 4 of the vacuum vessel 2, are structure-borne sound pick-ups 30-1, 30-2, 30-3 and 30-4, with which the acoustic signals created within and in the vicinity of the pan 6, by a vacuum pump for example, are picked up.

The structure-borne sound pick-ups 30-3, 30-4 may be permanently installed on the vacuum vessel 2 or on the cover 4 and can also be disposed within the vacuum vessel 2. They are not coupled acoustically directly to the wall of the pan 6. Instead the acoustic signals created in the pan 6 are transmitted via corresponding structures to the wall of the vacuum vessel 2 or to the cover 4.

The structure-borne sound pick-ups 30-1, 30-2 disposed on the outer wall of the pan 6 and coupled acoustically directly to the wall of the pan the 6 are removable, i.e. fixed releasably to the pan 6 and are only coupled to the pan 6 with quick-release fastenings after insertion of the pan 6 into the vacuum vessel 2.

The measurement signals M1, M2, M3 or M4 provided by the structure-borne sound pick-ups 30-1, 30-2, 30-3 and 30-4 in each case are forwarded to the control and evaluation device 40 in which they are evaluated and employed for detection of a leakage in the vacuum melting system.

The created measurement signals M1, M2, M3 and M4 are subjected to a signal analysis in the evaluation device 40 and with the assistance of a self-learning physical model the occurrence of operating states caused by leakages, for example by an incorrectly sealed cover 4, are recognized in good time and the corresponding deficiency can accordingly be rapidly rectified. To do this, in a learning phase before the actual commissioning, different operating states are set, for example operating the vacuum system with the cover closed correctly and not closed correctly, deliberate setting of leakages and the corresponding structure-born sound signals picked up. The frequency spectra of the measurement signals M1, M2, M3, M4 obtained in this learning phase created by a fast Fourier transformation are stored as a typical pattern so that, by comparing a frequency spectrum measured in real operation with the stored patterns, the occurrence and the cause, i.e. the location, of a leakage can be established.

The sound arising in the pan 6 from blowing the process gas P1, P2 into the steel melt propagates within the melt bath 14 and within the foamed slag 18 outwards to the wall, wherein the foamed slag 18 has a sound deadening effect. In other words: The depth d of the foamed slag 18 and its height H or location within the pan 6 significantly influences the sound signal especially picked up by the structure-borne sound pick-up 30-1 disposed in the upper area of the pan 6.

By analysis of the acoustic signals, the height H or the depth d of the foamed slag can therefore also be determined. To do this the frequency spectra of the measurement signals M1, M2, M3 and M4 are also compared in this application with frequency spectra which have been measured in a preceding learning phase for different operating states of the vacuum melting system, especially at different pressure in the vacuum vessel 2, different feeding rate of the process gases P1, P2 and also different heights of the foamed slag determined by recording with the camera. With the aid of learning and pattern detection algorithms, by comparing a real measured frequency spectrum with the frequency spectra obtained in the learning phase, the height H and especially the depth d of the foamed slag 18 or of its temporal differential dH/dt or dd/dt respectively can then be determined, without observation with the camera being required for this.

Control signals S1 and S2, with which the feeding rate of the process gases P1, P2 is controlled, are created in the control and evaluation device 40 as a function of the determined height H or depth d and may be a function of the determined differential quotients, to regulate the height of the foamed slag 18 to a constant value or at least to prevent an overfoaming of foamed slag 18.

In the exemplary embodiment shown a plurality of structure-born sound pick-ups are provided both on the pan 6 and also on the vacuum vessel 2. Basically however the method can also be performed with a single structure-borne sound pick-up 30-1, which may be disposed in the upper area of the pan.

Although the method and system have been illustrated and described in greater detail by exemplary embodiments, the invention is not restricted by the disclosed examples and other variations can be derived therefrom by the person skilled in the art, without departing from the spirit and scope of protection of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for operating a vacuum melting system for metallurgical treatment of a steel melt, comprising:
detecting acoustic signals generated in a pan accommodating the steel melt by at least one structure-borne sound pick-up acoustically coupled indirectly or directly to the pan; and
detecting leakage in the vacuum melting system based on the acoustic signals.

12. The method as claimed in claim 11, further comprising determining at least one of height and depth of foamed slag located in the pan above a melt bath of the steel melt based on the acoustic signals.

13. The method as claimed in claim 12, further comprising determining a temporal differential quotient of the at least one of height and depth of the foamed slag.

14. The method as claimed in claim 13, further comprising controlling feeding of a process gas into the pan based on at least one of the height, the depth and the temporal differential quotient of the at least one of height and depth of the foamed slag.

15. The method as claimed in claim 12, further comprising controlling feeding of a process gas into the pan based on at least one of the height, the depth and the temporal differential quotient of the at least one of height and depth of the foamed slag.

16. A vacuum melting system for metallurgical treatment of a steel melt in a pan, comprising:
at least one structure-borne sound pick-up acoustically coupled indirectly or directly to the pan, detecting acoustic signals generated in the pan; and
at least one programmed processor controlling operation of the vacuum melting system and detecting a leakage in the vacuum melting system based on the acoustic signals picked up by the at least one structure-borne sound pick-up.

17. The vacuum melting system as claimed in claim 16, wherein the at least one structure-borne sound pick-up is fixed to the pan.

18. The vacuum melting system as claimed in claim 17, wherein the at least one structure-borne sound pick-up is disposed in an upper area of the pan.

19. The vacuum melting system as claimed in claim 18, further comprising a system part surrounding the pan on which the at least one structure-borne sound pick-up is permanently installed.

20. The vacuum melting system as claimed in claim 19, wherein the at least one programmed processor further determines at least one of height and depth of foamed slag and/or a temporal differential quotient of the at least one of height and depth of the foamed slag based on the acoustic signals.

21. The vacuum melting system as claimed in claim 20, wherein the at least one programmed processor further regulates the at least one of height and depth of the foamed slag by controlling feeding of a process gas into the pan as a function of at least one of the height, the depth and the temporal differential quotient of the at least one of height and depth of the foamed slag.

22. The vacuum melting system as claimed in claim 18, wherein the at least one programmed processor further determines at least one of height and depth of foamed slag and/or a temporal differential quotient of the at least one of height and depth of the foamed slag based on the acoustic signals.

23. The vacuum melting system as claimed in claim 22, wherein the at least one programmed processor further regulates the at least one of height and depth of the foamed slag by controlling feeding of a process gas into the pan as a function of at least one of the height, the depth and the temporal differential quotient of the at least one of height and depth of the foamed slag.

24. The vacuum melting system as claimed in claim 17, further comprising a system part surrounding the pan on which the at least one structure-borne sound pick-up is permanently installed.

25. The vacuum melting system as claimed in claim 17, wherein the at least one programmed processor further determines at least one of height and depth of foamed slag and/or a temporal differential quotient of the at least one of height and depth of the foamed slag based on the acoustic signals.

26. The vacuum melting system as claimed in claim 25, wherein the at least one programmed processor further regulates the at least one of height and depth of the foamed slag by controlling feeding of a process gas into the pan as a function of at least one of the height, the depth and the temporal differential quotient of the at least one of height and depth of the foamed slag.

27. The vacuum melting system as claimed in claim 16, further comprising a system part surrounding the pan on which the at least one structure-borne sound pick-up is permanently installed.

28. The vacuum melting system as claimed in claim 27, wherein the at least one programmed processor further determines at least one of height and depth of foamed slag and/or a temporal differential quotient of the at least one of height and depth of the foamed slag based on the acoustic signals.

29. The vacuum melting system as claimed in claim 16, wherein the at least one programmed processor further determines at least one of height and depth of foamed slag and/or a temporal differential quotient of the at least one of height and depth of the foamed slag based on the acoustic signals.

30. The vacuum melting system as claimed in claim 29, wherein the at least one programmed processor further regulates the at least one of height and depth of the foamed slag by controlling feeding of a process gas into the pan as a function of at least one of the height, the depth and the temporal differential quotient of the at least one of height and depth of the foamed slag.
